(19) United States
(12) Patent Application Publication
(10) Pub. No.: US 2026/0364995 A1
(43) Pub. Date: Nov. 19, 2026

(54) Motor Vehicle with Air Conditioner

(71) Applicant: MAHLE International GmbH, Stuttgart (DE)

(72) Inventors: Holger LAUX, Dietingen (DE); Bailey REID, Lockport, NY (US); Kerstin WOCHELE, Friolzheim (DE)

(21) Appl. No.: 19/673,196

(22) Filed: May 11, 2026

(30) Foreign Application Priority Data
May 15, 2025 (DE) 102025118744.4

(51) Int. Cl. B60H 1/00; B60H 1/26

(52) U.S. Cl. CPC B60H 1/00814; B60H 1/00564; B60H 1/26

(57) ABSTRACT

A motor vehicle that has an air conditioner and doors that can open is provided. The air conditioner contains a fresh air channel, exhaust air channel, and a heat recovery device connected to the exhaust air channel for recovering heat from the vehicle cab, a ventilation channel is connected to the intake end of the heat recovery device that has an air control element, there is a pressure relief channel with a shut-off element, and there is a control unit for the air control element and the shut-off element, wherein the control unit is configured to open the shut-off element when a door is opened.

### CROSS-REFERENCE TO RELATED APPLICATIONS

This application claims priority from German Patent Application No. DE 102025118744.4, filed on May 15, 2025, the entirety of which is hereby incorporated by reference herein.

The present invention relates to a motor vehicle as set forth in the preamble of Numbered Paragraph 1. The invention also relates to a method for operating the motor vehicle.

When air-conditioning a vehicle cab, the temperature of fresh air is controlled by a heater in an air conditioner and exits the cab through a vehicle vent, or ventilation channel, as well as through leaks in the cab. Depending on the operating state, some exhaust air may be used to reduce the power consumption of the air conditioner. If the fresh air is allowed to flow through a heat recovery device, e.g. in a front-end air conditioner, this power consumption can be reduced even further. This can be activated or deactivated with vent flaps. If this is used for heat recovery, it must be ensured that the direct path to the exterior is shut off. This may result in an unpleasant pressure buildup in the cab if one of the doors is slammed shut.

To prevent this, relief flaps at the back are often used, which open vents if a door is slammed shut, to prevent pressure buildup. These relief flaps are usually just rubber flaps.

The disadvantage with this is that to open these flaps, there must be a predefined excess pressure in the cab, which may seem unpleasant. Furthermore, these flaps cannot be controlled precisely.

The present invention addresses the problem of creating a better or at least different design for such a vehicle, that results in greater comfort for the users of the vehicle.

This problem is solved by the subject matter of the independent Numbered Paragraph 1. Advantageous embodiments are the subject matter of the dependent Numbered Paragraphs.

The present invention is based on the general concept of using a shut-off element instead of the previously used relief flaps, which are often at the back of a vehicle and require a predefined excess pressure to open, that is automatically opened when a door is opened, connecting the vehicle interior (cab) with the exterior, such that there is no pressure buildup when closing doors. The vehicle in question has an air conditioner and doors, normally on the sides. The air conditioner has a fresh air channel, an exhaust air channel, and a heat recovery device connected to the exhaust air channel for heat recovery. The exhaust air channel is therefore connected to an intake on the heat recovery device. Power consumption for heating the cab is significantly reduced in cold weather by such a heat recovery device, because the exhaust heat from the cab is used in the heat recover device to heat the fresh air entering the cab from the exterior. The exhaust air channel, or at least one exhaust air channel, opens into the heat recovery device. A ventilation channel is also connected to the heat recovery device, which has an air control element that closes the ventilation channel in the heat recovery mode, such that the exhaust air taken from the cab can be used to heat the fresh air from outside. The ventilation channel is thus connected at its intake to an outlet on the heat recovery device. There is also a pressure relief channel with a shut-off element, and a control unit for the air control element and the shut-off element, which is configured to open the shut-off element when a door is open. This ensures that if the air conditioner is in the heat recovery mode, in which the air control element is closed in the ventilation channel, and the vehicle is parked and a door is open, there is no pressure buildup in the cab when the door is subsequently slammed shut, because the control unit has opened the shut-off element in the pressure relief channel, such that pressure is equalized by the pressure relief channel connected to the exterior and the cab. This combination of functions not only reduces power consumption when air-conditioning the vehicle, but also prevents an unpleasant pressure buildup when slamming vehicle doors shut.

The pressure relief channel is separate from the air conditioner. This pressure relief channel can be placed somewhere suitable for this that has not otherwise been used so far, which can be any number of locations.

The pressure relief channel can also be part of the air conditioner. This takes up less space, which is a major advantage in modern vehicles, in which there is very little free space. Moreover, by integrating the pressure relief channel in the air conditioner, the number of parts is reduced, and therefore warehousing, logistic and assembly costs are also reduced. This also simplifies control of the shut-off element, because there are already electric lines near the air conditioner.

The pressure relief channel forms a bypass for the heat recovery device in a particularly preferred design. In this case, the pressure relief channel is part of the air conditioner and only serves as a connection between the cab and the exterior when the air conditioner has been shut off and is still in the heat recovery mode as soon as one of the doors is opened.

The air conditioner has a housing that is part of the fresh air channel, exhaust air channel, heat recovery device, and/or pressure relief channel. This makes it possible to integrate as many of the aforementioned components as possible in the air conditioner housing, resulting in a particularly compact and inexpensive structure.

The housing is preferably an injection-molded plastic part. Injection-molded plastic parts are inexpensive to produce and of a high quality, which can be comparatively easily adapted to different installation spaces.

In an advantageous design, the motor vehicle obtained with the invention is an electric vehicle. Power-saving heating of the cab is of particular advantage with electric vehicles because this has a positive effect on the travel range. If it is possible to conserve energy by heating the cab with a heat recovery device, the travel range of the electric vehicle and the user's comfort can be significantly increased.

The present invention is also based on the general concept of creating a method for operating a vehicle according to the preceding paragraphs with which the advantages obtained with this vehicle can be applied to the method obtained with the invention. The control unit opens the shut-off element in the pressure relief channel when a door is open in the method obtained with the invention, such that even if an air conditioner is in the heat recovery mode, when it is abruptly shut off and the air control element remains closed, pressure can be equalized when shutting the doors.

Other important features and advantages of the invention can be derived from the dependent Numbered Paragraphs, drawings, and descriptions of the drawings.

It is understood that the features specified above and described below can be used not only in the given combinations, but also in other combinations or in and of themselves, without abandoning the scope of protection for the present invention. Components of a higher-order unit, e.g. an element, device, or assembly, specified above or below, which are indicated separately, can form separate components of this unit, or be integral parts thereof, even if otherwise indicated in the drawings.

Preferred exemplary embodiments of the invention are shown in the drawings and shall be explained in greater detail below, in which the same reference symbols are used for the same, similar, or functionally identical components.

Therein, schematically,

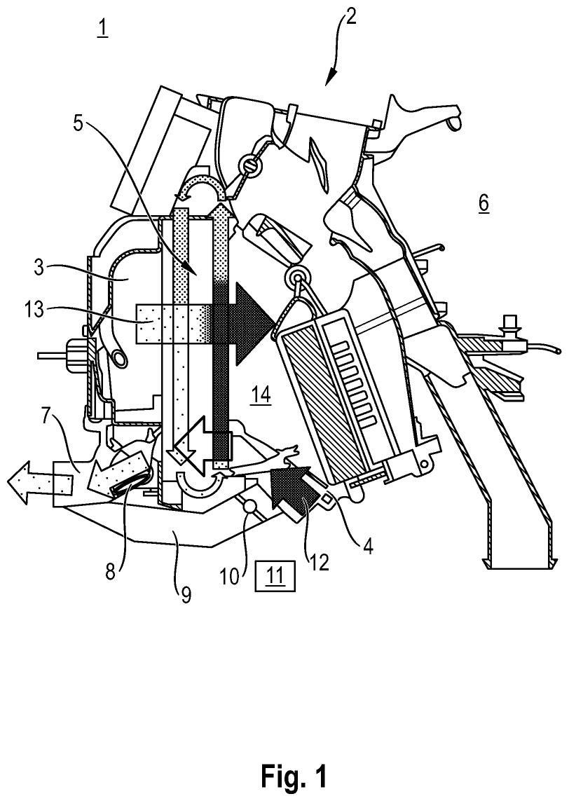

FIG. 1 shows a motor vehicle obtained with the invention that has an air conditioner with a closed shut-off element, and

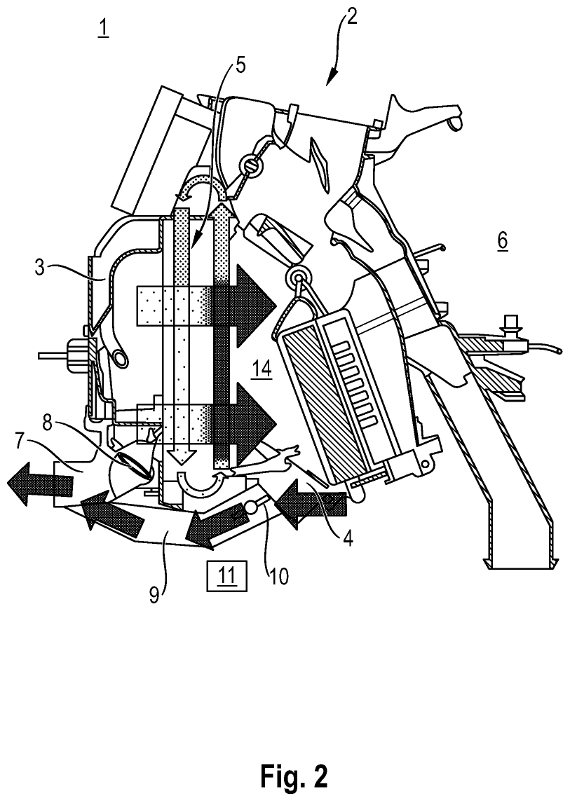

FIG. 2 shows the same as FIG. 1, but with the shut-off element open.

The motor vehicle 1 obtained with the invention has an air conditioner 2 and doors that can be opened, e.g. side doors. The air conditioner 2 has a fresh air channel 3, exhaust air channel 4, and a heat recovery device 5 connected to the exhaust air channel 4 for recovering heat from a vehicle cab 6. There is also a ventilation channel 7, which is connected at the intake end to the heat recovery device 5 and contains an air control element 8. The air control element 8 can be a pivoting shutter or a slider that can move laterally, which opens and closes the ventilation channel 7.

There is also a pressure relief channel 9 with a shut-off element 10, and this channel 9 is close to the air conditioner 2, or even a part thereof. Theoretically, the pressure relief channel 9 can be somewhere else in the vehicle 1.

The ventilation channel 7, and pressure relief channel 9 could also be shorter or longer than those shown in FIGS. 1 and 2.

There is also a control unit 11 for the air control element 8 and the shut-off element 10, which is configured to open the shut-off element 10 and thus the pressure relief channel 9 when a door is open.

The air conditioner 2 in the vehicle 1 obtained with the invention, which can be an electric vehicle, can conduct the exhaust air 12 flowing out of the cab 6 through the heat recovery device 5 to heat the cab in a power-saving manner, to transfer heat to fresh air 13 flowing into the cab. In this operating state, the shut-off element 10 is closed in the pressure relief channel, and in an air recirculation mode, the air control element 8 would also be closed in the ventilation channel 7.

If the air conditioner 2 is shut off in the air recirculation mode, i.e. when the air control element 8 is closed, the ventilation channel 7 is closed, as is the pressure relief channel 9, which is also closed by the closed shut-off element 10 in the air recirculation mode.

In this case, if a door on the vehicle is opened and subsequently slammed shut, an unpleasant pressure buildup occurs in the cab 6, which is prevented with the motor vehicle 1 obtained with the invention in that the control unit 11 opens the shut-off element 10 as soon as a door is opened. As a result, pressure is equalized by the pressure relief channel 9 regardless of the setting of the air control element 8 when the door is slammed shut, without any unpleasant pressure buildup in the cab 6.

In general, the pressure relief channel 9 can be part of the air conditioner 2, as shown in FIGS. 1 and 2, resulting in a particularly compact, resource conserving and therefore inexpensive construction. The pressure relief channel 9 can be a simple bypass channel, that bypasses the heat recovery device 5 by branching away from the exhaust air channel 4, entering the ventilation channel 7 downstream of the air control element 8.

Integration of the pressure relief channel 9 in the air conditioner 2 has the major advantage that the pressure relief channel 9 can be integrated in a housing 14 for the air conditioner 2, such that this housing 14, which is an inexpensive and high quality plastic injection-molded part, can contain not only the fresh air channel 3, the exhaust air channel 4, and the ventilation channel 7, but also the pressure relief channel 9.

The pressure relief channel 9 can also be placed elsewhere in the vehicle 1, in particular where there may be more space.

In addition to the motor vehicle 1 obtained with the invention, a method for operating such a vehicle 1 is also to be protected by this patent, in which the control unit 11 opens the shut-off element 10 as soon as a door on the vehicle is opened. The shut-off element 10 can be opened independently of the setting of the air control element 8 in the ventilation channel 7, but the shut-off element 10 must always be opened if the air control element 8 in the ventilation channel 7 is closed and a door is opened.

The vehicle 1 can be operated in a power-saving mode with the method obtained with the invention, because the exhaust air 12 from the cab 6 can be used to heat the fresh air 13 with the heat recovery device 5. Both the method and provision of the pressure relief channel 9, containing the shut-off element 10, can be implemented comparatively inexpensively.

If the vehicle 1 is an electric vehicle, not only can the comfort thereof be increased, because there is no pressure buildup when a door is slammed shut, but the vehicle can be operated in a power-saving mode, because heat can be obtained from the exhaust air 12 from the cab 6 with the heat recovery device 5 and used to heat the fresh air 13, before the exhaust air 12 is discharged through the ventilation channel 7 into the exterior.

Depending on the setting of the air control element 8 in the ventilation channel 7, a portion of the exhaust air discharged into the exterior through the ventilation channel 7 can be made use of. Particularly in the air recirculation mode, in which the air control element 8 is closed in the ventilation channel 7, the shut-off element 10 can be opened by the control unit 11 when the air conditioner is abruptly shut off, creating an open connection between the cab 6 and the exterior.

The specification can be readily understood with reference the following Numbered Paragraphs:

Numbered Paragraph 1. A motor vehicle (1) that has an air conditioner (2) and doors that can be opened, characterized in that
the air conditioner (2) contains a fresh air channel (3), exhaust air channel (4), and a heat recovery device (5) connected to the exhaust air channel (4) for recovering heat from the vehicle cab (6),
a ventilation channel (7) connected to the intake end of the heat recovery device (5) has an air control element (8),
there is a pressure relief channel (9) with a shut-off element (10),
there is a control unit (11) for the air control element (8) and the shut-off element (10), wherein the control unit (11) is configured to open the shut-off element (10) when a door is opened.

Numbered Paragraph 2. The vehicle (1) according to Numbered Paragraph 1, characterized in that the pressure relief channel (9) is separate from the air conditioner (2).

Numbered Paragraph 3. The vehicle (1) according to Numbered Paragraph 1, characterized in that the pressure relief channel (9) is part of the air conditioner (2).

Numbered Paragraph 4. The vehicle (1) according to any of the preceding Numbered Paragraphs, characterized in that the pressure relief channel (9) is a bypass channel and bypasses the heat recovery device (5).

Numbered Paragraph 5. The vehicle (1) according to any of the preceding Numbered Paragraphs, characterized in that the air conditioner (2) has a housing (14) that forms part of the fresh air channel (3), exhaust air channel (4), and pressure relief channel (9).

Numbered Paragraph 6. The vehicle (1) according to Numbered Paragraph 5, characterized in that the housing (14) is a plastic injection-molded part.

Numbered Paragraph 7. The vehicle (1) according to any of the preceding Numbered Paragraphs, characterized in that the vehicle (1) is an electric vehicle.

Numbered Paragraph 8. A method for operating a vehicle (1) according to any of the preceding Numbered Paragraphs, in which the control unit (11) opens the shut-off element (10) when a door is opened.

### LIST OF REFERENCE SYMBOLS

1 motor vehicle
2 air conditioner
3 fresh air channel
4 exhaust air channel
5 heat recovery device
6 cab
7 ventilation channel
8 air control element
9 pressure relief channel
10 shut-off element
11 control unit
12 exhaust air
13 fresh air
14 housing

1-8. (canceled)

9. A motor vehicle, comprising an air conditioner a one or more doors that are configured to be opened, wherein
the air conditioner comprises a fresh air channel, an exhaust air channel, and a heat recovery device connected to the exhaust air channel the heat recovery device is configured for recovering heat from the vehicle cab,
a ventilation channel is connected to an intake end of the heat recovery device, the ventilation channel comprises an air control element,
the air conditioner further comprises a pressure relief channel with a shut-off element,
further comprising a control unit for the air control element and the shut-off element, wherein the control unit is configured to open the shut-off element when a door of the one or more doors is opened.

10. The vehicle according to claim 9, wherein the pressure relief channel is separate from the air conditioner.

11. The vehicle according to claim 9, wherein the pressure relief channel is part of the air conditioner.

12. The vehicle according to claim 9, wherein the pressure relief channel is a bypass channel that includes a flow path that bypasses the heat recovery device.

13. The vehicle according to claim 9, wherein the air conditioner further comprises a housing that defines part of each of the fresh air channel, the exhaust air channel, and the pressure relief channel.

14. The vehicle according to claim 13, wherein the housing is a plastic injection-molded part.

15. The vehicle according to claim 9, wherein the vehicle is an electric vehicle.

16. A method for operating a vehicle according to claim 9, in which the control unit opens the shut-off element when a door of the at least one door is opened.
